(19) United States
(12) Patent Application Publication
(10) Pub. No.: US 2009/0231435 A1
(43) Pub. Date: Sep. 17, 2009

(54) PROTECTIVE HELMET

(75) Inventor: JIUN-NAN LU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/118,974

(22) Filed: May 12, 2008

(30) Foreign Application Priority Data
Mar. 11, 2008 (CN) 200810300512.4

(51) Int. Cl. H04N 7/18

(52) U.S. Cl. 348/158

(57) ABSTRACT

A protective helmet includes a main body defined an opening therein, a camera unit, a memory unit, and a power unit. The recording device is mounted on the opening of the main body and configured for capturing images. The memory unit is electrically connected to the recording device and received in the main body. The power unit is electrically connected to the recording device and configured for providing power for the recording device. The protective helmet can record all kinds of data including images and sound utilizing the camera unit and the recorder. Therefore, when having an unexplained accident, the data can be display again, which is a basis to analysis reason of the accident.

### RELATED FIELD

The present invention relates to a protective helmet, and more particularly, to a protective helmet having a recording device.

### BACKGROUND

Conventionally, a helmet is used for protecting a head of a wearer. When an unexpected accident happens, the wearer may be rescued, but details of the accident are not recorded.

It is desired to provide a protective helmet, which can overcome the above-described deficiency.

### SUMMARY

A protective helmet includes a main body defining an opening therein, a recording device, a dry battery, a light energy storage device, and a selection switch. The recording device is received in the opening. The memory unit is electrically connected to the recording device and mounted on the main body, and is configured for storing the information recorded by the recording device. The dry battery is electrically connected to the recording device and configured for providing power to the recording device. The light energy storage device is electrically connected to the recording device and configured for providing power to the recording device. The light energy storage device includes a solar cell plate and a storage battery electrically connected to the solar cell plate. The storage battery is configured for storing electric power produced by the solar cell plate. The selection switch is electrically connected to the recording device, the light energy storage device and the dry battery. The selection switch is configured for selecting either of the light energy storage device and the dry battery to provide power to the recording device.

Other novel features and advantages will become more apparent from the following detailed description when taken in conjunction with the accompanying drawings.

### BRIEF DESCRIPTION OF THE DRAWINGS

The present invention is described in detail hereinafter, by way of example and description of an exemplary embodiments thereof and with reference to the accompanying drawings, in which:

FIG. 1 is a schematic view of a protective helmet according to the exemplary embodiment; and

FIG. 2 is a top plan view of the protective helmet of FIG. 1.

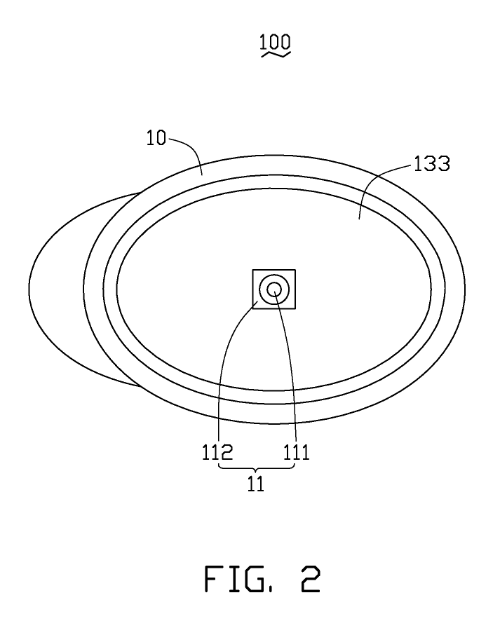

### DETAILED DESCRIPTION OF EXEMPLARY EMBODIMENTS

A detailed explanation of a protective helmet having a recoding device according to an exemplary embodiment of the present invention will now be made with reference to the drawings attached hereto.

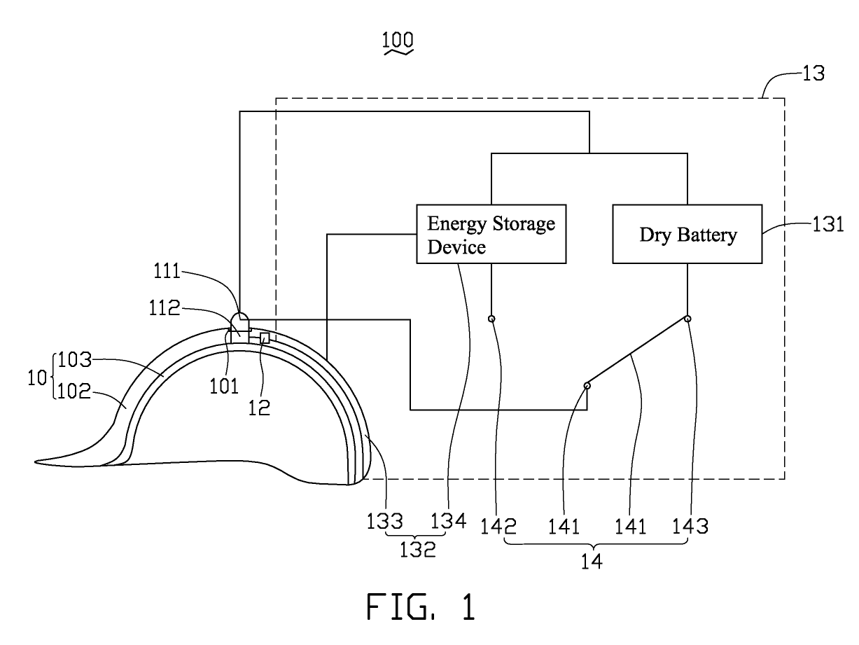

Referring to FIG. 1, FIG. 1 is a schematic view of a protective helmet 100 according to the exemplary embodiment is shown. The protective helmet 100 includes a main body 10 where an opening 101 is formed on, a recording device 11, a memory unit 12, a power unit 13 electrically connected to the recording device 11, and a selection switch 14.

The main body 10 is configured for covering the head of the wearer and includes an outer portion 102 and an inner portion 103 connected to the outer portion 102. The outer portion 102 is made of stiff material, such as metal, stiff plastic, or the like, for protecting the head of the wearer. Understandably, for comfort, the inner portion 103 is made of soft material, such as sponge, soft plastic, or the like, and is glued or otherwise adhered to an interior side of the outer portion 102. The opening 101 is disposed on the outer portion 102 and configured for receiving the recording device 11. The opening 101 can be disposed on any position of the outer portion 102. In the present embodiment, the opening 101 is disposed at top portion of the main body 10. Hence, the recording device 11 of the protective helmet 100 has substantially the same field of view as the wearer in this position.

The recording device 11 includes a camera unit 111 and an audio recorder 112. The camera unit 111 is of small size and light weight and can includes a single-chip image sensor, which can be a single-chip color CMOS image sensor or a charge coupled device (CCD) image sensor, and so on. The camera unit 111 is configured for capturing images of an exterior environment. The audio recorder 112 can be a microphone and configured for recording sound of the exterior environment.

The memory unit 12 is electrically connected to the recording device 11 and configured for storing data recorded by the recording device 11.

The power unit 13 includes a dry battery 131 and a light energy storage device 132. In other embodiments any kind of battery of sufficiently small size and having enough power can be applied to the power unit 13. The dry battery 131 is electrically connected to the recording device 11 and configured for providing power to the camera unit 111 and the audio recorder 112 of the recording device 11. The light energy storage device 132 is configured for converting light energy incident on a solar cell plate 133 of the light energy storage device 132 into electrical energy and storing the electrical energy in a storage battery 134 of the light energy storage device 132 electrically connected to the solar cell plate 133. The solar cell plates 133 is disposed on the outer portion 102.

The selection switch 14 can be a multi-channel switch or a single-pole multi-throw switch. The selection switch 14 includes an output end 141, two input ends 142, 143, and a pole 144. The pole 144 is electrically connected to the output end 141. The recording device 11 is electrically connected to the output end 141. The two input ends 142, 143 are respectively connected to the light energy storage device 132 and the dry battery 131. Thus, the selection switch 130 can be used to select either of the light energy storage device 132 and the dry battery 131 to provide energy to the recording device 11.

As described above, the protective helmet 100 can record information including images and sound utilizing the camera unit 111 and the recorder 112. Therefore, when an accident happens to a wearer wearing the protective helmet 100, the details can be recorded by the protective helmet 100 and data stored in the protective helmet 100 can be retrieved and analyzed.

It should be understood that the above-described embodiment is intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. A protective helmet, comprising:
a main body defined an opening therein;
a recording device installed in the opening;
a memory unit electrically connected to the recording device and mounted on the main body, the memory unit being configured for storing information recorded by the recording device;
a dry battery electrically connected to the recording device and configured for providing power to the recording device;
a light energy storage device electrically connected to the recording device and configured for providing the power to the recording device, the light energy storage device comprising a solar cell plate, and a storage battery electrically connected to the solar cell plate and configured for storing electric power produced by the solar cell plate; and
a selection switch electrically connected to the recording device, the light energy storage device, and the dry battery, and configured for selecting either of the light energy storage device and the dry battery to provide power to the recording device.

2. The protective helmet as claimed in claim 1, wherein the opening is disposed on a top side of the main body of the protective helmet.

3. The protective helmet as claimed in claim 1, wherein the recording device comprises a camera unit and an audio recorder, the camera unit is configured for capturing images, and the audio recorder is configured for recording sound.

4. The protective helmet as claimed in claim 3, wherein the audio recorder is a microphone.

5. The protective helmet as claimed in claim 1, wherein the selection switch is a multi-channel switch.

6. The protective helmet as claimed in claim 1, wherein the selection switch is a single-pole multi-throw switch.

7. The protective helmet as claimed in claim 1, wherein the selection switch comprises:
an output end electrically connected to the recording device;
two input ends electrically connected to the light energy storage device and the dry battery respectively; and
a pole electrically connected to the output end.

8. The protective helmet as claim 1, wherein the main body comprises an outer portion and an inner portion connected to the outer portion, and the solar cell plates is disposed on the outer portion.
